(19) United States
(12) Patent Application Publication
(10) Pub. No.: US 2011/0291513 A1
(43) Pub. Date: Dec. 1, 2011

(54) Annular Power Converter Having A Motive Effect

(76) Inventor: Kurt Schäfer, Kassel (DE)

(21) Appl. No.: 13/063,526

(22) PCT Filed: Sep. 9, 2009
(86) PCT No.: PCT/DE2009/001254

§ 371 Date: May 5, 2011

(30) Foreign Application Priority Data
Sep. 22, 2008 (DE) 10 2008 047 152.6

(51) Int. Cl. H02K 21/12

(52) U.S. Cl. 310/156.01

(57) ABSTRACT

The invention relates to an energy conversion apparatus between mechanical and electrical energy. In order to create a new geometry for the important system components of electric motors and electric generators, it is proposed to stationary arrange permanent magnets (14) in a ring-shape or in the inside of a ring. This ring including the permanent magnets (14) is then moved through the inside of the windings (16, 18) of a number of coils, which are stationary arranged along the ring circumference. Thereby, drive coils (16) are temporarily, chronologically exactly controlled powered. These coils accelerate the permanent magnets (14). Generator coils (18) may be used to decelerate the permanent magnets (14) and to feed the current into a current storage.

### STATE OF THE ART

The invention relates to an energy conversion apparatus between mechanical and electrical energy. According to the state-of-the-art of technology, such apparatuses are in part called electrical motors or generators. The electric motor principle can be described as follows:

In case of permanent excitement, the (stationary) stator operates as a permanent magnet with pole shoes. In case of electrical excitement, the stator acts as an iron core carrying the excitation coil and/or the excitation winding. If a current is channeled through the stator winding, a permanent magnetic field is generated in the stator (Ørsted principle).

In the inside of the stator a rotor is located, which in most cases consists of a coil with iron core (the so-called armature), which is pivot-mounted in the permanent magnetic field between the pole shoes of the stator. The armature is powered via a segmented commutator and sliding contacts (carbon brushes). If a current is channeled through the rotor, a permanent magnetic field is generated as well, which now interacts with the stator's magnetic field. Thus, the armature rotates around its own axis and switches the appropriate coils into the current path using the commutator, which is rotating as well. Thus, electrical energy is converted into mechanical energy.

If such a motor would not be fitted with a commutator, the armature would rotate, until the rotor's magnetic field and the stator's field would be commutated. To ensure that the motor does not stop in this “dead point”, the current in the armature coils is switched for every new segment using the commutator (called collector as well). The commutator consists of metal segments generating a cylinder or circular area interrupted by narrow strips of non-conducting material (plastic, air). The armature windings are connected to the segments. For the most part, two carbon brushes are pressed against the commuter using springs. They are used for supplying the power. Every rotor rotation changes the current direction through the armature windings. The conductors, whose current flow direction generates a moment of torque, enter the stator's permanent magnetic field. The rotor's permanent magnetic field is stationary. Thus, the iron core of the rotating armature must consist of a stack of metal sheets in order to avoid eddy currents.

In case of generators, the same principle is applied. The only difference is that a mechanical force is applied from the outside to the shaft driving the rotor. This results in a certain voltage and current on the stator. The resulting electrical energy can then be used for certain purposes.

The design geometry of the electric motors and electric generators mentioned above negatively restricts possible improvements of these important energy converters. Thus, the task of the presented invention is the introduction of a new geometry for the most important system components of electric motors and electric generators. This new geometry should enable application-specific, special design layouts of these motors and/or generators.

### ADVANTAGES OF THE INVENTION

The subject matter with the respective features of the independent claims solves this task.

Advantageous further developments and improvements of the respective subject matter of the invention can be found in the sub claims.

In short, the present invention contains the idea to stationary arrange permanent magnets in a ring-shape or in the inside of a ring. This ring including the permanent magnets is then moved through the inside of the windings of a number of coils, which are stationary arranged along the ring circumference. Thereby, drive coils are temporarily, chronologically exactly controlled powered. These coils accelerate the permanent magnets. Generator coils may be used to decelerate the permanent magnets and to feed the current into a current accumulator.

Now, if a permanent magnet passes through a de-energized coil, it generates an induction voltage surge when entering and exiting the coil. The subsequent permanent magnet would generate such voltage surges as well. The resulting electric energy can be tapped as electric energy generated (generator effect) by this arrangement, and possibly be further used.

Vice versa, if a permanent magnet passes through a coil, and this coil is energized at the correct point in time with a previously determined current, then the coil generates a magnetic field. This magnetic field contains a north and south pole with corresponding magnetic flux and corresponding field strength and lines of electric flux.

If the current is now, chronologically controlled, fed exactly then into the coil, when the north pole of the permanent magnet passes the north pole of the currently generated respectively just generated magnetic field of the coil, then a repelling effect is be observed, as e.g. north pole and north pole repel one another. This effect can be generated in parallel at several locations within the ring using respectively different coils and permanent magnets. This effect drives the ring filled with permanent magnets and populated with coils, and establishes the respective motor effect of the arrangement according to this invention.

Prior to the next permanent magnet entering the previously energized coil, the magnetic field must be removed in order to prevent deceleration of the next entering permanent magnet by the magnetic field of the coil. For this purpose, the current is reduced by the respective coil in time. The resulting induction voltage surge is used to feed a corresponding current via a resistor into a capacitor. Next, the coil will be energized again in a chronologically controlled manner. This ensures that the desired repelling force is generated at the proper point in time for the consecutive permanent magnet. Assuming suitable current feed pulse control and suitable filling of the ring with permanent magnets of suitable length, a moment of torque is applied to the ring. This requires that the permanent magnets are permanently fixed to the ring and cannot move within the ring.

The moment of torque applied to the ring is then used as motor moment. For this purpose, the ring is connected with a respective shaft via one or several mechanical connections.

This principle structure can be operated and used as generator or electric motor only or as a combination of both functions. For this purpose, an appropriate number of drive coils (also referred to as motor coils) and/or an appropriate number of generator coils are arranged along the ring circumference and accordingly actuated. If the number and electric energy of the drive coils prevails, then the result is a motor effect. Vice versa, if the generators establish larger energy consumption than the motors, then in sum a generator effect is achieved. In other words, this layout arrangement ultimately operates as generator for electric energy.

This electric energy can be tapped from the coils according to the state-of-the-art of technology. Vice versa, in case of the motor, the kinetic energy of the shaft can also be used according to the state-of-the-art of technology. Applications are in particular electric motors for motor vehicles and/or generators for motor vehicles, feeding the battery or any other energy storage, when the shaft is decelerated by energy generation.

According to the process-related main aspect of the present invention, an energy conversion method solely running as motor, for the conversion between electric and mechanical energy is disclosed, which is characterized by the following steps:
a) in a ring-shaped arrangement of ring-shaped permanent magnets mounted evenly spaced in a row, whose connection axis is tangentially directed with reference to the ring geometry, where a certain predefined number of drive coils and/or a certain predefined number of generator coils is arranged along the ring circumference of the ring-shaped arrangement, the permanent magnets are passed through the coils while moving the ring-shaped arrangement around its center point,
b) Recording the passing of a pole of a permanent magnet mentioned, using a predefined recording location while moving the ring,
c) Depending on the ring velocity, more or less temporary energizing the previously mentioned drive coils, where current is respectively obtained from a buffer, a respective temporary magnetic field is generated by energizing the respective drive coil, where energizing takes place at certain points in times defined by the recording device and a control device, of passing a pole of a permanent magnet by a pole of the same denominator of a respective, temporary magnetic field. This results in acceleration of the motion of the respective permanent magnets and of the entire ring-shaped arrangement.

According to another process-related main aspect of the present invention, an energy conversion method solely running as generator, for the conversion between electric and mechanical energy is disclosed, which is characterized by the following steps:
d) in a ring-shaped arrangement of ring-shaped permanent magnets mounted evenly spaced in a row, whose connection axis is tangentially directed with reference to the ring geometry, where a certain predefined number of drive coils and/or a certain predefined number of generator coils is arranged along the ring circumference of the ring-shaped arrangement, the permanent magnets are passed through the coils while moving the ring-shaped arrangement around its center point,
e) Feeding an inductive current from one of the previously mentioned generator coils into the buffer at times, when the respective permanent magnet enters or exits a generator coil, at which a respective permanent magnet and the ring-shaped arrangement are decelerated.

According to another process-related main aspect of the present invention, an energy conversion method running as motor and generator, is disclosed, which is operated in one arrangement with drive coils and generator coils, and which can execute steps a) to e) in combination.

According to other advantageous aspects of the present invention, the ring geometry according to this invention can be extended by concentric arrangement of several of such rings. The actuation wires for the coils to be energized are either arranged between the rings or in one plane vertically to the common ring axis, adjacent to one respective ring. This way the generator output respectively motor output per unit of volume can be increased.

Several of such ring arrangements mentioned above and/or concentric ring arrangement just mentioned can be arranged in a row in order to create a cylinder with a further increased height. The base area of the cylinder would be the area covered by the outer ring of one “disk”. The cylinder height would in principle be the sum of the width dimensions of the individual rings arranged in a row and/or the multiple rings or disks. The control will be accommodated in a clearance between the individual disks as well. Using this approach, the power density and/or the power output will be further increased.

According to a basic apparatus-related aspect of the present invention, an energy conversion apparatus is disclosed, which to a certain extend features a self-propelling generator and a motor effect. This apparatus is characterized by the following attributes:
a) a ring-shaped arrangement of ring-shaped permanent magnets mounted evenly spaced in a row and—preferably—featuring the same north/south orientation, whose connection axis of the permanent magnet poles is—preferably—tangentially directed with reference to the ring geometry,
b) where a certain predefined number of drive coils, and a certain predefined number of generator coils is arranged along the ring circumference, so that the permanent magnets are passed through the coils while moving the ring around its center point,
c) where at least one recording device exits, which records passing of a pole of a permanent magnet mentioned while moving the ring,
d) an apparatus for specific feeding of energy into one of the previously mentioned drive coils at a point in time defined by the recording device, where current is respectively obtained from a buffer storage, and based on which one of the permanent magnets is accelerated, and the entire ring-shaped arrangement is accelerated as well, as the permanent magnets are mechanically coupled with one another,
e) An apparatus for specific feeding of an induction current from one of the previously mentioned generator coils into the buffer storage. This causes a deceleration of one of the permanent magnets and of the entire ring-shaped arrangement, as the permanent magnets are mechanically permanently coupled. They are, for example, permanently mounted to the ring at a suitable location in the ring,
f) An energy buffer storage, which can be used to specifically draw current and to feed current into,
g) Whereby, the ring-shaped arrangement is routed through the inside of the coils, hence the clearance generated by the coil windings, for a concentric motion around the ring center point.

The previously mentioned magnets arranged in a row are advantageously permanent magnets and not electric magnets. They must be energized first in order to generate a permanent magnetic field.

The ring-shaped arrangement is advantageously designed as ring-shaped tube, in whose inside the permanent magnets are arranged. The ring-shaped arrangement is supported by the fact that the ring is located in the internal spaces available within the individual coils, hence drive and consumer coils. A low-friction coating is provided on the outer surface of the ring as well as on the inner surface of the lead-through holes in the coils, to ensure as minimum friction as possible, when the permanent magnets are moved by the repelling effect. Alternatively or in combination, the ring can be mounted on movable rolls or rollers.

The permanent magnets in the inside of the ring are permanently fixed to the ring. Their spacing to one another is fixed as well, as the permanent magnets are mounted on predefined locations in the inside of the ring. Depending on the main application purpose of the apparatus according to the invention, either the number of drive coils outweighs the number of generator coils, or vice versa. The number of these coils and the ratios of these numbers to one another depend on the electric layout of these coils.

The purpose of the recording device, which records passing of a pole of one or several of the permanent magnets mentioned while the ring is moving, is to determine an optimal point in time, at which current is fed into the drive coils. This then causes the coils to generate a corresponding permanent magnetic field, which at this point in time is oriented in such a way that it repels the passing pole of the permanent magnet. The repulsion processes are synchronized by synchronization of the respective locations and times of drive coil energizing. This ensures optimum repulsion.

The apparatus for specific drive coil energizing preferably contains power transistors, whose control electrode receives a current signal generated by the recording device previously mentioned. The recording device can process signals, which can e.g. be generated by a light barrier arrangement, which detects a north pole or south pole of a moving permanent magnet pass a certain, stationary marker, such as e.g. the north pole location of the generated magnetic field of a motor coil. The correct point in time for temporary energizing of a motor coil can also be based on the detection of the voltage peak, which is induced when the permanent magnet enters into the drive coil, and its use for control purposes.

The apparatus for the specific current drain of the induction current mentioned above taps the voltage generated on the generator coils and feeds the induced current into a buffer storage. In this case this is an electric capacitor. The capacitor is charged in parallel using feed currents from every generator coil. For this purpose, a corresponding parallel circuit of these feeding devices is provided. The capacitor is connected to its end.

If current should be drawn from the capacitor, as it is the case here, if the drive coils should be energized via power transistors, then the collector-emitter path of the power transistor is located between the capacitor and a pole of the respective drive coil. For this purpose, a parallel circuit should be provided for the respective number of drive coils. This circuit connects the capacitor via the power transistors to the respective drive coils.

Instead of one single capacitor a number of capacitors can be provided, for example for a certain number of drive coils and a certain number of generator coils.

### DRAWINGS

Execution examples of the invention are presented in the drawings and explained in more details in the description below. All drawings are meant as schematic presentations.

FIG. 1 shows an overview presentation of the important system components of an execution example of an apparatus according to the invention;

FIG. 2 schematically shows the entry of the permanent magnet into a generator coil;

FIG. 3 schematically shows the exit of the permanent magnet out of a generator coil;

FIG. 4 schematically shows the entry of the permanent magnet into a drive coil;

### DESCRIPTION OF THE IMPLEMENTATION EXAMPLES

In the drawings, the same reference symbols describe the same or functionally equivalent components.

With respect to drawing 1, the energy conversion apparatus 10 according to the execution example, mainly contains a ring-shaped arrangement 12 as well as several switching elements, which are available either centrally for the entire ring-shaped arrangement or individually for each of the shown coils, hence for drive coils 16—called motor coils as well—and generator coils 18.

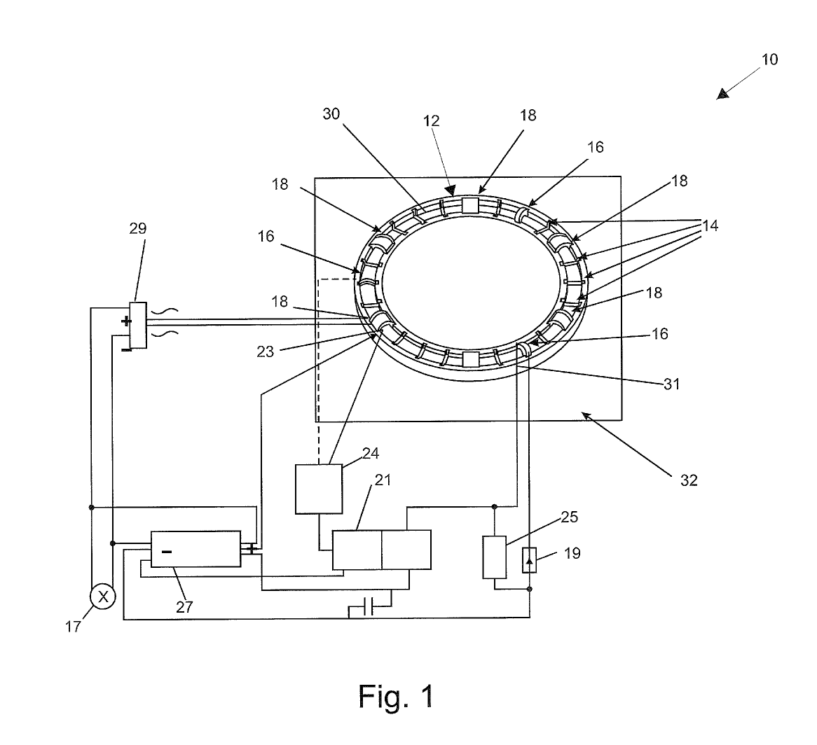

In particular, a multitude of permanent magnets 14 is evenly spaced within a plastic ring 15 and fixated at pre-defined locations for example by gluing. In FIG. 1, 24 permanent magnets, 6 generator coil and 3 motor coils are provided in respectively even distances.

In this case the permanent magnets have the following approx. dimensions:

Cylindrical design, segmented in three serially consecutively secured individual magnets, total length approx. 15 mm, diameter approx. 25 mm. The ring diameter amounts to approx. 60 cm, the ring cross section diameter approx. 30 mm.

In this execution example three drive coils 16 are arranged at an angular distance of 120°, six generator coils are arranged at an angular distance of 60°, where the drive coils are centered between two generator coils.

A simplified illustration of the corresponding control circuit for the actuation of one motor coil and one generator coil each, is shown in the bottom left of FIG. 1. The actuators for the other coils are available, however have been omitted from the drawing for better clarity of the figure.

The electrical connection for each of the generator coils 18 mentioned is implemented as follows:

The voltage of generator coils 18 is tapped via a rectifier 29, and the current is fed to a consumer 17, a battery 27 and a capacitor 22. Thereby, electric energy is fed into the mentioned elements. A blocking diode 19 is to be provided together with a farristor 25, in order to energize a motor coil 16 respectively using a direct current of the correct sign and current-limited and voltage-limited.

The point in time and the duration of current and voltage pulse for energizing is implemented via a controller 24 together with a light barrier. This apparatus for specific energizing of the drive coils preferably contains a power transistor (or a relay), whose control electrode receives a current signal generated by the previously mentioned light barrier arrangement as recording device of the correct energizing time.

The recording device can process signals, which can be generated by the light barrier arrangement, which detects a north pole or south pole of a moving permanent magnet pass a certain, stationary marker, such as e.g. the north pole location of the generated magnetic field of a motor coil. The correct point in time for temporary energizing of a motor coil can also be based on the detection of the voltage peak, which is induced when the permanent magnet enters into the drive coil, and its use for control purposes.

A commercially available light barrier circuit is used. This circuit outputs an output signal, with a time offset as needed. Here, the respective time delay can be adjusted. With higher ring velocity, the controller according to this invention reduces the delay.

If the permanent magnets are evenly spaced and the motor coils are evenly spaced, and both system elements feature the same design, then a single control signal can be used to energize several drive coils. This simplifies the control scheme. Thus, the mentioned recording device for the timing of current feeding into the drive coils can simply be available and ensure energizing of all drive coils, or it can be individually provided for every drive coil.

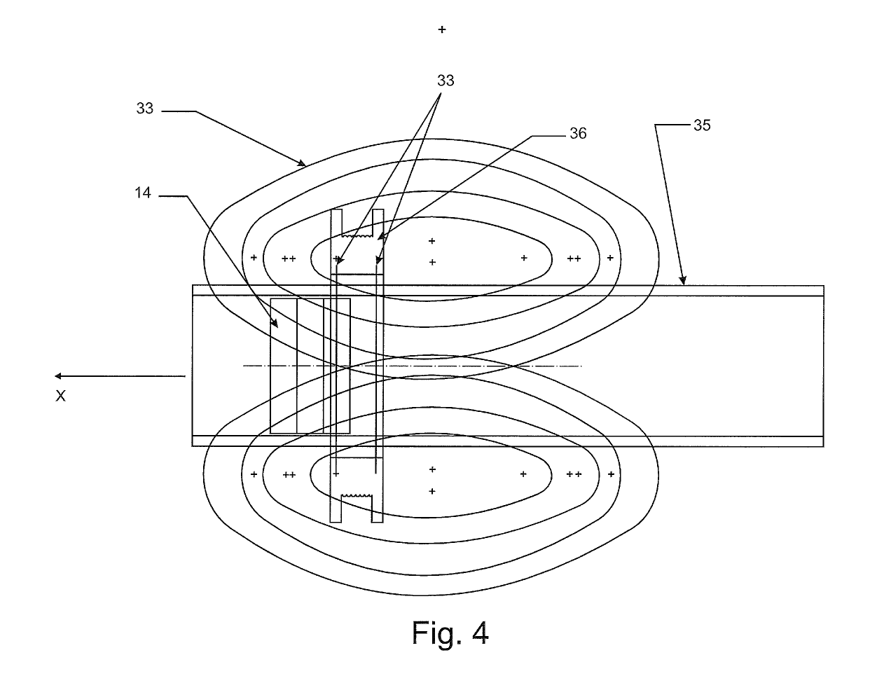

It is important to ensure the energizing pulse takes place at the correct moment in time, when the rear pole in the direction of travel of the permanent magnet passes the temporarily generated magnetic field. This is presented in FIG. 4.

Suitable time duration of the energizing pulse is adjustable depending on the velocity and can be easily optimized using experiments. The control of the reduction of the time delays mentioned above with increasing ring velocity can be based on the time difference between two consecutive light barrier signals.

In the following, the functionality of the coils will be explained, while the permanent magnets pass through them within the moving ring.

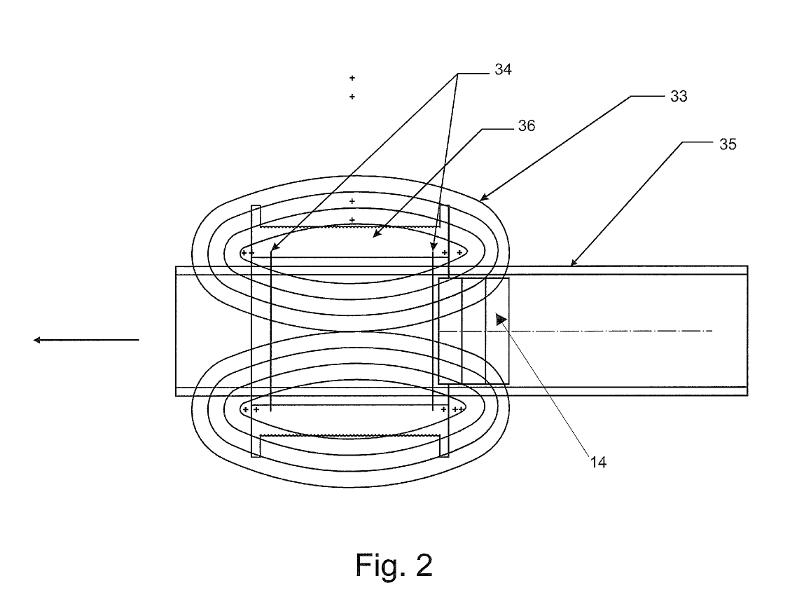

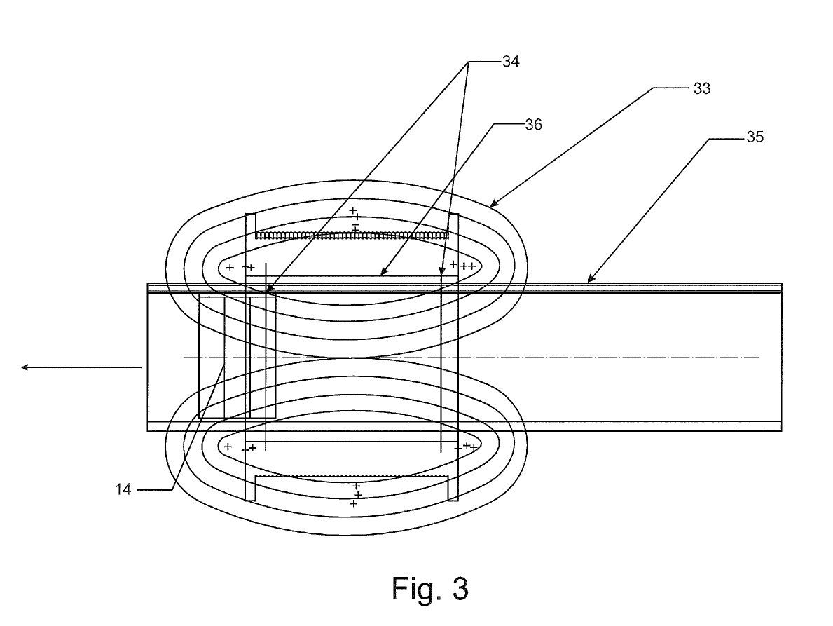

With reference to FIG. 2, the moving permanent magnet 14 just enters the generator coil, moving from the right to the left, see arrow. The permanent magnet 14 passes through the inside of the generator coil windings on a quasi-linear path and exits the windings again, see FIG. 3. This results in the induction of an induction voltage into the coil, showing approx. sinusoidal characteristics over time. The average duration may e.g. amount to 1/10 of a second. Among other things, the intensity of induction depends on the generator coil design and the strength of the permanent magnet.

With reference to FIG. 4, the moving permanent magnet 14 just exits the drive coil, moving from the right to the left, see arrow. Prior to that, the permanent magnet 14 passed through the inside of the drive coil on a quasi-linear path.

Among other things, the intensity of induction depends on the drive coil design and the strength of the permanent magnet.

During entry (not shown), an induction voltage pulse is induced in the coil. Preferably, this pulse can also be used to control the energizing timing of controller 24, see the dotted line to controller 24.

One pole of drive coil 16 is connected to the minus pole of the capacitor via the power transistor 21. At the above mentioned point in time—which is exactly right to energize the drive coil, light barrier 23 generates a signal, which connects power transistor 21.

In this moment, electric charge is drawn from capacitor 22, the drive coil or motor coil 16 is energized and a magnetic field is generated, which generates a repulsion from the pole of the same denominator of the moving permanent magnet at exactly this point in time, so that permanent magnet 14 is strongly and exactly repelled, when exiting drive coil 16.

The difference of the poles of the same denominator of motor coil magnetic field and magnetic field of permanent magnet 14 with reference to the direction of travel, x-direction, tangential direction, can for example amount to 10% of the different in length between north and south pole of the motor coil at the time of the newly generated magnetic field. At the beginning of the energizing pulse, the pole of the permanent magnet should be in direct proximity of the pole of the same denominator of the magnetic field of the motor coil just being generated. This ensures that the pole of the same denominator of the moving magnet passes the pole of the stationary magnet exactly in time, when the quickly being generated magnetic field becomes effective. Thus, a maximum repulsion can take place, accelerating the ring, minimizing deceleration as much as possible. The more accurate and faster the magnetic field in the motor coil can be generated, the better is the acceleration.

Thus, the acceleration of the repelled permanent magnet and—based on its permanent connection to the ring—the acceleration of the ring motion result exactly from the chronological control realized by light barrier 23, power transistor 21.

Although the present invention is here described using a preferred execution example, the invention shall not be limited to this, but can be modified in many ways.

The effective coil length can be varied by intermediate tapping as needed

The permanent magnets can be arranged in different (and not necessarily uniform) north pole-south pole orientations, especially, when the drive coils can be alternately connected in such a way that they can generate magnetic field with both (opposing) directions. Thereby, detection and identification of a passing pole of a permanent magnet can be individually determined for every permanent magnet, for example by evaluation of the voltage peak, which was generated in the previous coil by induction, or via light barriers and possibly different markers for north and south pole, recorded by the light barrier. It is also possible to have several light barriers per coil. For example one, which detects approaching south poles, and another one to detect the corresponding north poles.

Finally, the attributes in the sub claims can be basically freely combined, and not only in the order provided here in the claims, as long as they are independent from one another.

1. A method for the conversion of energy between electric energy and mechanical energy comprising the steps of:
a) in a ring-shaped arrangement of ring-shaped permanent magnets mounted evenly spaced in a row, whose connection axis is tangentially directed with reference to the ring geometry, wherein a certain predefined number of drive coils and/or a certain predefined number of generator coils is arranged along the ring circumference of the ring-shaped arrangement, passing the permanent magnets through the coils while moving the ring-shaped arrangement around its center point;
b) recording the passing of a pole of one of said permanent magnets, using a predefined recording location while moving the ring-shaped arrangement; and
c) energizing said drive coils, wherein current is respectively obtained from a buffer, a respective temporary magnetic field is generated by energizing the respective drive coil, wherein energizing takes place at certain points in times defined by the recording device and a control device, of passing a pole of a permanent magnet by a pole of the same denominator of a respective, temporary magnetic field.

2. An energy conversion method for the conversion of energy between electric and mechanical energy, comprising the steps of:
d) in a ring-shaped arrangement of ring-shaped permanent magnets mounted evenly spaced in a row, whose connection axis is tangentially directed with reference to the ring geometry, wherein a certain predefined number of drive coils and/or a certain predefined number of generator coils is arranged along the ring circumference of the ring-shaped arrangement;
the permanent magnets are passed through the coils while moving the ring-shaped arrangement around its center point; and
e) feeding an inductive current from one of the previously mentioned generator coils into the buffer at times, when the respective permanent magnet enters or exits a generator coil.

3. A method according to claim 1, in an arrangement with drive coils and generator coils, where steps a) to e) are executed in combination.

4. An energy conversion apparatus comprising:
a) a ring-shaped arrangement of ring-shaped permanent magnets mounted evenly spaced in a row, whose connection axis of the permanent magnet poles is tangentially directed with reference to the ring geometry;
b) wherein a certain predefined number of drive coils is arranged along the ring circumference, so that the permanent magnets are passed through the coils while moving the ring around its center point;
c) wherein at least one recording device exits, which records passing of a pole of a permanent magnet mentioned while moving the ring; and
d) an apparatus for specific energizing of the previously mentioned drive coils at a point in time defined by the recording device, wherein current is respectively obtained from a current source and based on which the permanent magnets are accelerated, and the entire ring-shaped arrangements is accelerated as well, as the permanent magnets are mechanically coupled with each other.

5. An energy conversion apparatus comprising:
a) a ring-shaped arrangement of ring-shaped permanent magnets mounted evenly spaced in a row, whose connection axis of the permanent magnet poles is tangentially directed with reference to the ring geometry;
b) wherein a certain predefined number of generator coils is arranged along the ring circumference, so that the permanent magnets are passed through the coils while moving the ring around its center point;
c) an apparatus to specifically tap current from the generator coils previously mentioned, wherein current is fed into a buffer accumulator;
d) the buffer storage for current, in which current can be fed; and
e) wherein the ring-shaped arrangement is guided for a concentric motion around the ring's center point through openings in the coils.

6. Apparatus An energy conversion apparatus according to claim 4, further comprising:
e) an apparatus to specifically tap current from the generator coils previously mentioned, wherein current is fed into a buffer accumulator,
f) the buffer storage for current, in which current can be fed,
g) wherein the ring-shaped arrangement is guided for a concentric motion around the ring's center point through openings in the coils.

7. An energy conversion apparatus according to claim 4, wherein the permanent magnets are arranged within the hollow ring, which is permanently mounted to the permanent magnets.

8. An energy conversion apparatus according to claim 4, wherein the recording device includes a light barrier, which detects a circular with circumferential marking.

9. An energy conversion apparatus according to claim 6, wherein the drive coil output prevails and the apparatus operates as a motor.

10. An energy conversion apparatus according to claim 6, wherein the generator coil output prevails and the apparatus operates as a generator.

11. An energy conversion apparatus claim 4, wherein several rings are arranged concentrically in one plane and generate a disk.

12. An energy conversion apparatus claim 4, wherein several disks are arranged with a common center axis, generating a cylinder, which amounts to a multiple of a ring thickness.

13. An energy conversion apparatus according to claim 5, wherein the permanent magnets are arranged within the hollow ring, which is permanently mounted to the permanent magnets.

14. An energy conversion apparatus according to claim 6, wherein the permanent magnets are arranged within the hollow ring, which is permanently mounted to the permanent magnets.

15. An energy conversion apparatus according to claim 5, wherein several rings are arranged concentrically in one plane and generate a disk.

16. An energy conversion apparatus according to claim 5, wherein several disks are arranged with a common center axis, generating a cylinder, which amounts to a multiple of a ring thickness.
